(19) United States
(12) Patent Application Publication
(10) Pub. No.: US 2006/0057736 A1
(43) Pub. Date: Mar. 16, 2006

(54) Methods and devices for fabricating chemical arrays

(76) Inventors: Bill J. Peck, Mountain View, CA (US); Eric M. Leproust, San Jose, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/940,165

(22) Filed: Sep. 13, 2004

(51) Int. Cl. B01L 3/00

(52) U.S. Cl. 436/174; 436/180

(57) ABSTRACT

The subject invention provides methods and devices for fabricating chemical arrays. Also provided are chemical arrays fabricated according to the subject methods, and methods of using chemical arrays produced according to the subject invention.

### BACKGROUND OF THE INVENTION

Chemical arrays such as biopolymer arrays (for example polynucleotide array such as DNA or RNA arrays) are known and are used, for example, as diagnostic or screening tools. Such arrays include regions of usually different sequence polynucleotides arranged in a predetermined configuration on a substrate.

These regions (sometimes referenced as “features”) are positioned at respective locations (“addresses”) on the substrate. The arrays, when exposed to a sample, will exhibit an observed binding pattern. This binding pattern can be detected upon interrogating the array. For example all polynucleotide targets (for example, DNA) in the sample can be labeled with a suitable label (such as a fluorescent compound), and the fluorescence pattern on the array accurately observed following exposure to the sample. Assuming that the different sequence polynucleotides were correctly deposited in accordance with the predetermined configuration, then the observed binding pattern will be indicative of the presence and/or concentration of one or more polynucleotide components of the sample.

Arrays may be fabricated by depositing previously obtained biopolymers onto a substrate, or by in situ synthesis methods. The in situ fabrication methods include those described in U.S. Pat. No. 5,449,754 for synthesizing peptide arrays, and in U.S. Pat. No. 6,180,351 and WO 98/41531 and the references cited therein for synthesizing polynucleotide arrays. Further details of fabricating biopolymer arrays are described in U.S. Pat. No. 6,242,266; U.S. Pat. No. 6,232,072 and U.S. Pat. No. 6,171,797. Other techniques for fabricating biopolymer arrays include known light directed synthesis techniques.

Methods for sample preparation, labeling, and hybridizing are disclosed for example in U.S. Pat. No. 6,201,112; U.S. Pat. No. 6,132,997; U.S. Pat. No. 6,235,483 and US patent publication 20020192650.

After an array has been exposed to a sample, the array is read with a reading apparatus (such as an array “scanner”) which detects the signals (such as a fluorescence pattern) from the array features. The signal image resulting from reading the array may then be digitally processed to evaluate which regions (pixels) of read data belong to a given feature as well as the total signal strength from each of the features. The foregoing steps, separately or collectively, are referred to as “feature extraction”.

As chemical arrays are used more and continue to play important roles in a variety of applications, there continues to be an interest in the development of methods and devices for the fabrication of chemical arrays.

### SUMMARY OF THE INVENTION

Methods and devices for fabricating chemical arrays are provided.

Embodiments of the subject methods include depositing a volume of fluid onto an array region of an array substrate surface and observing an optical property of the feature region that includes the deposited volume to determine the volume of fluid deposited at the feature region. Embodiments also include methods for performing an array assay. Also provided are chemical arrays fabricated according to embodiments of the subject methods.

Methods for performing an array assay are also described. Embodiments for performing an array assay include (a) contacting a sample to at least one chemical array fabricated by depositing a volume of fluid onto an array region of an array substrate surface and observing an optical property of the feature region that includes the deposited volume to determine the volume of fluid deposited at the feature region, and (b) detecting the presence of any binding complexes from the chemical array.

Also provided are apparatuses for fabricating a chemical array on a substrate surface. Apparatus embodiments include a fluid deposition system to deposit a volume of fluid at a feature region of an array substrate surface, an imaging system to capture an image of a volume of fluid deposited at the feature region, and a processor for causing the imaging system to capture an image of a volume of fluid deposited at a feature region of an array substrate surface and for comparing the captured image to reference.

Computer readable medium with programming recorded thereon are also provided by the subject invention. Embodiments include a computer readable medium from controlling an apparatus to observe an optical property of a volume of fluid deposited at a feature region of an array substrate surface, and determine the volume of the deposited fluid based on the observed optical property.

Also provided are kits. Embodiments include an array assembly and error information, associated with the array assembly, that includes information obtained by a method of the subject invention.

### BRIEF DESCRIPTIONS OF THE DRAWINGS

FIG. 1 shows an exemplary embodiment of the subject invention for fabricating a chemical array having a fluid deposition device, an imaging system and a processor.

FIG. 2 shows two droplets being deposited at a feature region of an array substrate surface according to the subject invention.

### DEFINITIONS

A “biopolymer” is a polymer of one or more types of repeating units.

Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions.

Polynucleotides include single or multiple stranded configurations, where one or more of the strands may or may not be completely aligned with another.

Specifically, a “biopolymer” includes DNA (including cDNA), RNA and oligonucleotides, regardless of the source.

A “monomer” references a single unit, which can be linked with the same or other monomers to form a polymer (for example, a single amino acid or nucleotide with two linking groups one or both of which may have removable protecting groups). A monomer fluid or polymer fluid reference a liquid containing either a monomer or polymer, respectively (typically in solution).

The terms “nucleoside” and “nucleotide” are intended to include those moieties which contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

Reference to a “droplet” merely refers to a discrete small quantity of fluid and does not require any particular shape. For example, reference to a “droplet” being dispensed from a pulse jet herein, merely refers to a discrete small quantity of fluid (e.g., less than about 1000 pL) being dispensed upon a single pulse of the pulse jet (corresponding to a single activation of an ejector) and does not require any particular shape of this discrete quantity.

When two items are “associated” with one another they are provided in such a way that it is apparent that one is related to the other, e.g., where one references the other.

“Optical property” is meant broadly to refer to a property related (a property that is a function of) how a material (droplet) reacts to exposure to light. When light strikes an object such as a fluid droplet, the light may be transmitted, absorbed, or reflected.

“Grayscale image”, “grayscale profile” and “grayscale signature” are used interchangeably to refer to an image in which the value of each pixel is represented by a single value representing overall luminance (on a scale from black to white).

Displayed images of this sort are typically composed of shades of gray, varying from black at the weakest intensity to white at the strongest, though in principle the image could be displayed as shades of any color, or even coded with various colors for different intensities. While embodiments are described herein with respect to grayscale images, it will be apparent that any pixel coding may be employed.

By “capturing” an image is meant that a processor obtains an image from an imaging capture device for analysis.

“Operator alert” refers to any method and/or device for informing an operator of information (including instructions, data, and the like), a situation, etc.

Operator alerts may be in any medium or form and may be visual and/or audible. In certain embodiments, an operator alter may be an observation of the termination of a process, such as the halting of an array fabrication process. An “operator” refers to an agent, human, computer or other mechanism capable of controlling a device and/or process. For example, in certain aspects an operator may be a human being.

In certain aspects an operator may be computing means, e.g., configured to perform tasks such as automated tasks, related to the subject invention

“Audio or visual output device” is meant broadly to refer to a device adapted to transmit or communicate information (including instructions, data, images, and the like), a situation, etc., audibly or visually.

By “identifier” is meant broadly to refer to any item or method for connecting, linking, or communicating information (including identity, instructions, data, and the like), a situation, etc., about the item with which it is associated.

“Fluid” is used herein to reference a liquid.

Items of data are “linked” to one another in a memory when a same data input (for example, filename or directory name or search term) retrieves those items (in a same file or not) or an input of one or more of the linked items retrieves one or more of the others. In particular, when error information, array layout information, etc., is “linked” with an identifier for that array, then an input of the identifier into a processor which accesses a memory carrying the linked array layout retrieves the error information, array layout, etc. for that array. Data may be linked in a relational database, for example.

“Activator” refers to any suitable chemical and/or physical entity that is employed to make-possible, assist, enhance or increase in the joining or linking of a monomer to another chemical entity such as one or more other monomers or a reactive functional group such as a free hydroxy functional group present on a substrate surface, etc. For example, an activator may protonate a monomer so that it may be joined to another monomer or to a free functional group. For example, activators may be employed in phosphoramidite chemistry where they used in the joining of a deoxynucleoside phosphoramidite to a functional group present on a substrate surface or to another deoxynucleoside phosphoramidite. In producing nucleic acids on a substrate surface using phosphoramidite chemistry, one of the first steps in such a protocol involves attaching a first monomer to the substrate surface. Accordingly, a solution containing a protected deoxynucleoside phosphoramidite and an activator, such as tetrazole, benzoimidazolium triflate (“BZT”), S-ethyl tetrazole, and dicyanoimidazole, is applied to the surface of a substrate that has been chemically prepared to present reactive functional groups such as, for example, free hydroxyl groups. The activators tetrazole, BZT, S-ethyl tetrazole, and dicyanoimidazole are acids that protonate the amine nitrogen of the phosphoramidite group of the deoxynucleoside phosphoramidite. A free hydroxyl group on the surface of the substrate displaces the protonated secondary amine group of the phosphoramidite group by nucleophilic substitution and results in the protected deoxynucleoside covalently bound to the substrate via a phosphite triester group. An analogous methodology using an activator may be employed to link two deoxynucleoside phosphoramidites together such as a deoxynucleoside phosphoramidite to a substrate bound nucleotide. For example, a protected deoxynucleoside phosphoramidite in solution with an activator is applied to the substrate-bound nucleotide and reacts with the 5′ hydroxyl of the nucleotide to covalently link the protected deoxynucleoside to the 5′ end of the nucleotide via a phosphite triester group. In accordance with the subject invention, suitable “activators” include, but are not limited to, tetrazole and tetrazole derivatives such as S-ethyl tetrazole, dicyanoimidazole (“DCI”), benzimidazolium triflate (“BZT”), and the like. Activators are usually, though not always, present in a liquid, typically in solution, where such may be referred to as a “fluid activator”. In describing the subject invention, an activator includes an activator alone or with a suitable medium such as a fluid medium or the like. As such, an activator and a fluid activator may be used interchangeably herein.

An “oligonucleotide” generally refers to a nucleotide multimer of about 10 to 100 nucleotides in length, while a “polynucleotide” includes a nucleotide multimer having any number of nucleotides.

A chemical “array”, unless a contrary intention appears, includes any one, two or three-dimensional arrangement of addressable regions bearing a particular chemical moiety or moieties (for example, biopolymers such as polynucleotide sequences) associated with that region. For example, each region may extend into a third dimension in the case where the substrate is porous while not having any substantial third dimension measurement (thickness) in the case where the substrate is non-porous. An array is “addressable” in that it has multiple regions (sometimes referenced as “features” or “spots” of the array) of different moieties (for example, different polynucleotide sequences) such that a region at a particular predetermined location (an “address”) on the array will detect a particular target or class of targets (although a feature may incidentally detect non-targets of that feature). Such a region may be referred to as a “feature region”. The target for which each feature is specific is, in representative embodiments, known. An array feature is generally homogenous in composition and concentration and the features may be separated by intervening spaces (although arrays without such separation can be fabricated).

The terrn “binding” refers to two objects associating with each other to produce a stable composite structure. Such a stable composite structure may be referred to as a “binding complex”. In certain embodiments, binding between two complementary nucleic acids may be referred to as specifically hybridizing. The terms “specifically hybridizing,” “hybridizing specifically to” and “specific hybridization” and “selectively hybridize to,” are used interchangeably and refer to the binding, duplexing, complexing or hybridizing of a nucleic acid molecule preferentially to a particular nucleotide sequence under stringent conditions.

In the case of an array, the “target” will be referenced as a moiety in a mobile phase (typically fluid), such as a sample, to be detected by probes (e.g., cytotoxic probes) which are bound to the substrate at the various regions.

However, either of the “target” or “target probes” may be the one which is to be detected by the other (thus, either one could be an unknown mixture of polynucleotides to be detected by binding with the other). “Addressable set of probes” and analogous terms refers to the multiple regions of different moieties supported by or intended to be supported by the array surface.

An array “assembly” includes a substrate and at least one chemical array, e.g., on a surface thereof. Array assemblies may include one or more chemical arrays present on a surface of a device that includes a pedestal supporting a plurality of prongs, e.g., one or more chemical arrays present on a surface of one or more prongs of such a device. An assembly may include other features (such as a housing with a chamber from which the substrate sections can be removed). “Array unit” may be used interchangeably with “array assembly”.

An “array layout” or “array characteristics”, refers to one or more physical, chemical or biological characteristics of the array, such as positioning of some or all the features within the array and on a substrate, one or more feature dimensions, or some indication of an identity or function (for example, chemical or biological) of a moiety at a given location, or how the array should be handled (for example, conditions under which the array is exposed to a sample, or array reading specifications or controls following sample exposure).

“Reading” signal data from an array refers to the detection of the signal data (such as by a detector) from the array. This data may be saved in a memory (whether for relatively short or longer terms).

The term “reference” is used to refer to a known value or set of known values against which an observed value may be compared.

A “package” is one or more items (such as an array assembly optionally with other items) all held together (such as by a common wrapping or protective cover or binding). Normally the common wrapping will also be a protective cover (such as a common wrapping or box) which will provide additional protection to items contained in the package from exposure to the external environment. In the case of just a single array assembly a package may be that array assembly with some protective covering over the array assembly (which protective cover may or may not be an additional part of the array unit itself).

“Hybridizing” and “binding”, with respect to polynucleotides, are used interchangeably.

A “plastic” is any synthetic organic polymer of high molecular weight (for example at least 1,000 grams/mole, or even at least 10,000 or 100,000 grams/mole.

“Flexible” with reference to a substrate or substrate web, references that the substrate can be bent 180 degrees around a roller of less than 1.25 cm in radius.

The substrate can be so bent and straightened repeatedly in either direction at least 100 times without failure (for example, cracking) or plastic deformation. This bending must be within the elastic limits of the material. The foregoing test for flexibility is performed at a temperature of 20° C. “Rigid” refers to a material or structure which is not flexible, and is constructed such that a segment about 2.5 by 7.5 cm retains its shape and cannot be bent along any direction more than 60 degrees (and often not more than 40, 20, 10, or 5 degrees) without breaking.

When one item is indicated as being “remote” from another, this is referenced that the two items are at least in different buildings, and may be at least one mile, ten miles, or at least one hundred miles apart. When different items are indicated as being “local” to each other they are not remote from one another (for example, they can be in the same building or the same room of a building). “Communicating”, “transmitting” and the like, of information reference conveying data representing information as electrical or optical signals over a suitable communication channel (for example, a private or public network, wired, optical fiber, wireless radio or satellite, or otherwise). Any communication or transmission can be between devices which are local or remote from one another. “Forwarding” an item refers to any means of getting that item from one location to the next, whether by physically transporting that item or using other known methods (where that is possible) and includes, at least in the case of data, physically transporting a medium carrying the data or communicating the data over a communication channel (including electrical, optical, or wireless). “Receiving” something means it is obtained by any possible means, such as delivery of a physical item (for example, an array or array carrying package). When information is received it may be obtained as data as a result of a transmission (such as by electrical or optical signals over any communication channel of a type mentioned herein), or it may be obtained as electrical or optical signals from reading some other medium (such as a magnetic, optical, or solid state storage device) carrying the information. However, when information is received from a communication it is received as a result of a transmission of that information from elsewhere (local or remote).

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly.

A “computer”, “processor” or “processing unit” are used interchangeably and each references any hardware or hardware/software combination which can control components as required to execute recited steps. For example a computer, processor, or processor unit may include a general purpose digital microprocessor suitably programmed to perform all of the steps required of it, or any hardware or hardware/software combination which will perform those or equivalent steps. Programming may be accomplished, for example, from a computer readable medium carrying necessary program code (such as a portable storage medium) or by communication from a remote location (such as through a communication channel).

A “memory” or “memory unit” refers to any device which can store information for retrieval as signals by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

To “record” data, programming or other information on a computer-readable medium refers to a process for storing information, using any such methods as are known in the art. Any convenient storage structure may be chosen, based on the means to access the stored information. A variety of data processor programs and formats may be used for data storage, e.g., word processing text file, databases format, etc.

An array “assembly” includes a substrate and at least one chemical array on a surface thereof. An assembly may include other features (such as a housing with a chamber from which the substrate sections can be removed). “Array unit” may be used interchangeably with “array assembly”.

A “package” is one or more items (such as an array assembly optionally with other items) all held together (such as by a common wrapping or protective cover or binding). Normally the common wrapping will also be a protective cover (such as a common wrapping or box) which will provide additional protection to items contained in the package from exposure to the external environment. In the case of just a single array assembly a package may be that array assembly with some protective covering over the array assembly (which protective cover may or may not be an additional part of the array unit itself).

It will also be appreciated that throughout the present application, that words such as “cover”, “base” “front”, “back”, “top”, “upper”, and “lower” are used in a relative sense only.

“May” refers to optionally.

When two or more items (for example, elements or processes) are referenced by an alternative “or”, this indicates that either could be present separately or any combination of them could be present together except where the presence of one necessarily excludes the other or others.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1 M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions that set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application No. 09/655,482 filed on Sep. 5, 2000, the disclosure of which is herein incorporated by reference) followed by washes of 0.5×SSC and 0.1 ×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

As used herein, the term “contacting” means to bring or put together. As such, a first item is contacted with a second item when the two items are brought or put together, e.g., by touching them to each other.

“Depositing” means to position, place an item at a location-or otherwise cause an item to be so positioned or placed at a location. Depositing includes contacting one item with another. Depositing may be manual or automatic, e.g., “depositing” an item at a location may be accomplished by automated robotic devices.

The term “sample” as used herein refers to a fluid composition, where in certain embodiments the fluid composition is an aqueous composition.

The term “assessing” “inspecting” and “evaluating” are used interchangeably to refer to any form of measurement, and includes determining if an element is present or not. The terms “determining,” “measuring,” “assessing,” and “assaying” are used interchangeably and include both quantitative and qualitative determinations. Assessing may be relative or absolute. “Assessing the presence of” includes determining the amount of something present, as well as determining whether it is present or absent.

### DETAILED DESCRIPTION OF THE INVENTION

Methods and devices for fabricating chemical arrays are provided.

Embodiments of the subject methods include depositing a volume of fluid onto an array region of an array substrate surface and observing an optical property of the feature region that includes the deposited volume to determine the volume of fluid deposited at the feature region. Embodiments also include methods for performing an array assay. Also provided are chemical arrays fabricated according to embodiments of the subject methods. The subject invention also includes one or more chemical arrays fabricated according to embodiments of the subject methods present in a kit format. For example, embodiments may include an array assembly having one or more chemical arrays fabricated according to embodiments of the subject methods and error information associated with the array assembly, where the associated error information may include information related to the fabrication of the array assembly.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All patents and publications mentioned herein are incorporated herein by reference in their entirety. The citation of any patent or publication is for its disclosure prior to the filing date and should not be construed as an admission that the present invention is not entitled to antedate such publication by virtue of prior invention.

Further, the dates of publication provided may be different from the actual publication dates which may need to be independently confirmed.

It must be noted that as used herein and in the appended claims, the singular forms “a”, “an”, and “the” include plural referents unless the context clearly dictates otherwise.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The figures shown herein are not necessarily drawn to scale, with some components and features being exaggerated for clarity.

Methods of Fabricating a Chemical Array

The subject invention provides methods of fabricating chemical arrays (e.g., a polynucleotide or, more specifically, a DNA or RNA array) on a substrate surface.

Embodiments of the subject invention include depositing a volume of fluid used in array fabrication at a feature region of a surface of an array substrate and inspecting the deposited volume to obtain information about the volume and/or array fabrication process itself. The subject invention is particularly well suited for use in non-destructively inspecting a fabricated array, e.g., determining the volume of a deposited fluid, e.g., in high throughput manufacturing processes.

As noted above, there are two main ways of producing chemical arrays on an array substrate surface. In one method, previously synthesized nucleic acids/polypeptides, cDNA fragments, etc., are deposited onto the surface of the substrate in the form of an array made up of a plurality of features or spots each feature including multiple copies of the pre-synthesized polymer. Another method involves the in situ synthesis of polymers on an array substrate surface in which polymers are “grown” on the surface of the substrate in a step-wise fashion to produce a chemical array made up of a plurality of features or spots each feature including multiple copies of the in situ synthesized polymer.

The subject methods may be employed to determine whether an inspected volume of fluid deposited at a feature region of an array substrate contains the correct, e.g., targeted (i.e., intended), volume of fluid, which information may be used to verify whether an inspected volume of fluid includes all of the intended reagents. For example, a volume of fluid deposited at a feature region of a substrate during in situ array fabrication may be intended to include a plurality of different droplets of the same or different reagent. By determining the volume of the fluid actually deposited at the feature region, an observation about whether all of the intended reagents (and/or as well as the intended amounts thereof) have in fact been deposited may be made or whether one or more reagents failed to be deposited, e.g., due to fluid deposition system failure.

In practicing the subject methods, a volume of fluid is deposited at a feature region of an array substrate surface. It is to be understood that methods of the present invention may be executed without the deposition step in the event that a volume of fluid was previously provided on the substrate. The fluid may be any fluid used in the fabrication of one or more chemical arrays on a substrate surface, as will be described in greater detail below. For example, the fluid may contain previously synthesized biopolymer, may contain monomers, activator, and the like.

A volume of fluid to be evaluated according to the subject invention may be deposited on a wide variety of array substrates, including both flexible and rigid substrates. The particulars of a substrate upon which the fluid is deposited is not particularly important to the subject methods as a wide variety of substrates may be employed. One requirement of a substrate is that it does not adversely interfere with the observance of the optical property of the fluid.

The array substrate may be selected from a wide variety of materials including, but not limited to, natural polymeric materials, particularly cellulosic materials and materials derived from cellulose, such as fiber containing papers, e.g., filter paper, chromatographic paper, etc., synthetic or modified naturally occurring polymers, such as nitrocellulose, cellulose acetate, poly (vinyl chloride), polyamides, polyacrylamide, polyacrylate, polymethacrylate, polyesters, polyolefins, polyethylene, polytetrafluoro-ethylene, polypropylene, poly (4-methylbutene), polystyrene, poly(ethylene terephthalate), nylon, poly(vinyl butyrate), cross linked dextran, agarose, etc.; either used by themselves or in conjunction with other materials; fused silica (e.g., glass), bioglass, silicon chips, ceramics, metals, and the like.

The substrates may take any of a variety of configurations ranging from simple to complex. Suitable substrates may exist, for example, as sheets, tubing, spheres, containers, pads, slices, films, plates, slides, strips, disks, etc. The substrate may be flat, but may take on alternative surface configurations in certain embodiments. The substrate may be a flat glass substrate, such as a conventional microscope glass slide or the like, a cover slip, and the like. Substrates that may be used include surface-derivatized glass or silica, or polymer membrane surfaces, and the like.

The substrate surface onto which the volume of fluid is deposited may be smooth or substantially planar, or have irregularities, such as depressions or elevations. The surface may be modified with one or more different layers of compounds that serve to modify the properties of the surface in a desirable manner.

Such modification layers, when present, may range in thickness from a monomolecular thickness to about 1 mm, e.g., from a monomolecular thickness to about 0.1 mm, e.g., from a monomolecular thickness to about 0.001 mm. Modification layers of interest include, but are not limited to: inorganic and organic layers such as metals, metal oxides, polymers, small organic molecules and the like.

Polymeric layers of interest include layers of: peptides, proteins, polynucleic acids or mimetics thereof (for example, peptide nucleic acids and the like);

polysaccharides, phospholipids, polyurethanes, polyesters, polycarbonates, polyureas, polyamides, polyethyleneamines, polyarylene sulfides, polysiloxanes, polyimides, polyacetates, and the like, where the polymers may be hetero- or homopolymeric, and may or may not have separate functional moieties attached thereto (for example, conjugated).

The substrate may have generally planar form, as for example a slide or plate configuration, such as a rectangular or square or disc. In certain embodiments, the substrate may be shaped generally as a rectangular solid, having a length ranging from about 4 mm to about 1 m, e.g., from about 4 mm to about 600 mm, e.g., from about 4 mm to about 400 mm; a width ranging from about 4 mm to about 1 m, e.g., from about 4 mm to about 500 mm, e.g., from about 4 mm to about 400 mm; and a thickness that ranges from about 0.01 mm to about 5.0 mm, e.g., from about 0.1 mm to about 2 mm, e.g., from about 0.2 to about 1 mm. However, larger substrates may be used, e.g., when such are cut after fabrication into smaller size substrates carrying a smaller total number of arrays.

Embodiments of the subject methods employ a manually or automatically activated fluid deposition apparatus to deposit a volume of fluid at a feature region of an array substrate. Of interest in the practice of the subject methods are highly automated fluid drop deposition apparatuses may be used in certain embodiments, e.g., used in high throughput chemical array manufacturing formats, such a pulse jet deposition devices (e.g., piezoelectric pulse jet devices and the like). In such embodiments, some or all fluid deposition processes are executed by a processing system.

Embodiments of fluid drop deposition apparatuses that may find use with the subject methods include a dispensing head (or plurality of heads) which may be of a type commonly used in an ink jet type of printer and includes one or more, and in many embodiments a plurality, of dispensing orifices. A head may, for example, have about one hundred fifty drop dispensing orifices or more, e.g., in each of two parallel rows, six chambers for holding polynucleotide solution communicating with the three hundred orifices, and three hundred ejectors which may be positioned in the chambers opposite a corresponding orifice. Each ejector may be in the form of an electrical resistor operating as a heating element under control of processor (although piezoelectric elements may be used instead). Each orifice with its associated ejector and chamber or portion of the chamber, defines a corresponding pulse jet with the orifice acting as a nozzle. In this manner, application of a single electric pulse to an ejector causes a volume of fluid to be dispensed from a corresponding orifice. The foregoing head system and other suitable dispensing head designs are described, e.g., in U.S. Pat. Nos. 6,461,812; 6,323,043; 6,599,693. However, other head system configurations may be used.

It should be understood though, that the present invention is not limited to pulse jet type deposition devices. Any type of array fabrication apparatus adapted to deposit a volume of fluid at a feature region of an array substrate may be used as a fabricator according to the subject invention, including those such as described in U.S. Pat. No. 5,807,522, or an apparatus which may employ photolithographic techniques for forming arrays of moieties, or any other suitable apparatus which may be used for fabricating arrays of moieties.

In certain embodiments, an inspected volume of fluid may include a plurality of droplets deposited at a feature region of a substrate surface. For example, one or more droplets (e.g., 2, 3, 4, 5, 6, or more), of the same or different fluid, may be deposited at a given feature region of an array substrate surface, e.g., some or all of the individual droplets may be dispensed from different jets of a pulse-jet fluid drop deposition device. Once deposited at a feature region, the individual droplets may be considered a volume of fluid for purposes of the subject invention in that the individual droplets or sub-volumes may coalesce or merge together to provide a finally-deposited, single droplet on the substrate surface, which final droplet is made-up of the individually deposited volumes of fluid. The subject methods may then be employed to determine the volume of the final droplet that is made-up of two or more individual droplets. In this manner, the final droplet may be inspected and a determination of whether all (and/or the intended amounts thereof) required droplets have in fact been deposited may be made (i.e., whether the inspected volume of fluid includes all the individual droplets required or intended to be included in the final, inspected droplet).

A volume of fluid deposited at a feature region and evaluated according to the subject methods may be any fluid used in chemical array fabrication. In certain embodiments the subject methods may be employed to evaluate a volume of fluid deposited onto a surface of an array substrate in the in situ fabrication of chemical arrays. Such embodiments, as described above, may employ highly automated fluid drop deposition devices such as pulse-jet fluid deposition devices in which thermal or piezo pulse jet devices analogous to inkjet printing devices to deposit fluids of polymeric precursor molecules, i.e., monomers, onto a substrate surface, as described above. In embodiments of such in situ protocols, a series of droplets, e.g., each containing one particular type of reactive deoxynucleoside phosphoramidite, is sequentially applied to each discrete area or “feature”, sometimes referred to as a “spot”, of the chemical array by a pulse-jet printhead. These automated deposition devices may be configured to have one or more reservoirs, each containing a specific reagent such as a particular monomer, activator, etc., in communication with one or more printheads of the device. The reagents of the reservoirs are thus deposited onto a substrate surface at a feature region via the printheads of the device. U.S. Patents disclosing thermal and/or piezo pulse jet deposition of biopolymer containing fluids onto a substrate include: U.S. Pat. Nos. 6,242,266; 6,232,072; 6,180,351; 5,028,937; 5,807,522; 6,171,797; 6,447,723 and 6,323,043.

In situ protocols for synthesizing polynucleotides (specifically DNA) may employ phosphoramidite or other chemistry which may be generally regarded as iterating the sequence of depositing droplets of (a) a protected monomer onto predetermined locations on a substrate to link with either a suitably activated substrate surface or with a previously deposited deprotected monomer; (b) deprotecting the deposited monomer so that it can react with a subsequently deposited protected monomer; and (c) depositing another protected monomer for linking. Different monomers may be deposited at different regions on the substrate during any one cycle so that the different regions of a completed array will carry the different biopolymer sequences as desired in the completed array. One or more further steps may be required in each iteration, such as activation, oxidation, capping, washing steps, etc.

In the in situ synthesis of nucleic acid arrays using phosphoramidite synthesis protocols, the 3′-hydroxyl group of an initial 5′-protected nucleoside is first covalently attached a substrate surface. Synthesis of the nucleic acid then proceeds by deprotection of the 5′-hydroxyl group of the attached nucleoside, followed by coupling of an incoming nucleoside-3′-phosphoramidite to the deprotected 5′ hydroxyl group (5′-OH). The resulting phosphite triester is finally oxidized to a phosphotriester to complete the internucleotide bond. The steps of deprotection, coupling and oxidation are repeated until a nucleic acid of the desired length and sequence is obtained. Optionally, capping may be performed before and/or after oxidation to stop further reaction of the surface attached DNA strand that failed to couple.

Accordingly, in situ synthesis involves the deposition of suitable volumes of fluid at feature regions of an array substrate surface in sequences of layers, until the desired length and sequence of a given nucleic acid is obtained. A given synthesis layer at least includes one drop of predetermined volume of phosphoramidite base and one drop of predetermined volume of an activating agent, where in certain embodiments a layer may include more than one drop of phosphoramidite base and more than one drop of an activating agent, e.g., a layer may includes three drops of phosphoramidite base and three drops of an activating agent, etc. The droplets need not be deposited simultaneously for a given layer, e.g., one or more drops of a phosphoramidite base may be deposited at a given feature for a particular synthesis layer prior to the deposition of one or more drops of activator at that feature area, or vice versa, or some or all of the drops may be deposited at the same time.

Regardless of the number of droplets in a synthesis layer, both of the phosphoramidite and the activating agent must be present to achieve synthesis at a given layer. When deposited using a fluid deposition system such as a pulse jet deposition device or the like to deposit the droplets, usually the phosphoramidite and the activating agent are deposited from different nozzles of the device. In embodiments where multiple droplets of one type of reagent are deposited at a given synthesis layer (e.g., two, three or more droplets of a given phosphoramidite), each droplet may be deposited from the same or different orifices of a pulse jet deposition device. In any event, it will be apparent that a malfunction in the firing of one or more jets will result in an incomplete synthesis layer as one or more chemicals may be totally absent from the layer or the amount of one or more chemicals may be insufficient.

The present invention provides methods to non-destructively inspect one or more layers of a synthesis in order to determine the quality of the layer, e.g., the volume of fluid at that layer. In this manner, the determined fluid volume, in turn, may be used to determine whether the correct or rather intended (predetermined) number of droplets (or stated otherwise the intended volume of fluid) have been deposited at the feature region. Embodiments include employing the subject methods to determine whether a given synthesis layer, or whether all of the synthesis layers, of a given synthesis, that are intended to include one or more droplets (i.e., a particular amount) of a given phosphoramidite and one or more droplets of an activating agent (e.g., deposited from respective pulse jets), do in fact include the intended amount of each reagent. Evaluation may be with respect to some or all synthesis layers, e.g., each layer may be evaluated, or just a sub-set of a given synthesis may be evaluated.

In certain embodiments in which the fluids that provide an evaluated droplet at a feature region are deposited from one or more pulse-jets of a pulse jet printhead, embodiments of the subject methods enable the determination not only in instances in which all of the nozzles that eject the phosphoramidite and all of the nozzles that eject the activator have failed to deposit respective droplets (i.e., no fluid is deposited at all), but also in instances in which just a fraction of the nozzles, e.g., one of the nozzles, has failed to deposit a droplet of a respective fluid (i.e., only a given phosphoramidite or activator is actually deposited such that the device has failed to deposit one of the reagents). In those embodiments in which a synthesis layer is intended to include a plurality of droplets of a given phosphoramidite fluid (e.g., three droplets) and a plurality of droplets of activator fluid (e.g., three droplets), embodiments of the subject methods may be employed to determine qualitatively or quantitatively the fluid volume of the actual layer (droplet) formed, which information may be used to determine the number of droplets actually deposited on a substrate surface, e.g., may be employed to determine whether one droplet is missing, two, three, four, five or all six droplets are missing (if six droplets are intended to be present), and may be repeated for each successive synthesis.

Once a volume of fluid is deposited at a feature region of an array substrate, regardless of what the fluid is actually made-up of (whether the correct amount of phosphoramidite and the correct amount of activator or not), the deposited fluid may then be inspected. Inspection of a fluid includes observing one or more properties, such as one or more optical properties, of a deposited volume of fluid.

By observing one or more properties such as one or more optical properties, the volume of the deposited fluid may be determined based on the one or more observed properties such as the one or more observed optical properties. Embodiments of the subject methods include observing one or more aspects related to the transmission and/or absorption and/or reflection of light from deposited droplet.

Embodiments include capturing an image of a deposited fluid. An image capture device may be employed to capture one or more images of a droplet on a substrate, e.g., a suitably configured camera. Image capture devices that may be adapted for use in the subject invention are described, e.g., in U.S. Pat. Nos. 6,589,739 and 6,689,319.

According to the subject invention, a volume of a droplet deposited at a feature site, and especially a hydrophilic feature, may be determined by observing the grayscale signature of a deposited fluid droplet. Differences in the grayscale image of a single droplet deposited at a feature site, e.g., the site of previously deposited droplets (i.e., previous synthesis layers), as compared to the grayscale image of two or more droplets deposited at the site of previously deposited droplets (i.e., previous synthesis layers), may be detected.

Accordingly, the subject methods include capturing the grayscale image of a feature region at given synthesis layer and determining the volume of fluid at that synthesis layer according to the layer's grayscale profile. To determine the volume of fluid based on the grayscale of a synthesis layer, the obtained grayscale signature may be compared to a reference such as a lookup table of referenced grayscale metrics, i.e., a table that includes grayscale values for various fluid volumes for a given fluid.

For example, as noted above, synthesis layers may include more than one droplet of fluid deposited at the feature site, e.g., may include three individual droplets of phosphoramidite and three individual droplets of activator (referred to as a 3+3 synthesis) which 6 deposited droplets have merged together to provide a final, single droplet. In embodiments where two or more of such synthesis layers are present at a feature site for a given synthesis, the grayscale profile of a single droplet, e.g., of a given phosphoramadite or activator, deposited at the feature site differs from the grayscale of two or more droplets deposited at the feature site.

Accordingly, in accordance with embodiments of the subject invention, observing the grayscale profile of a deposited droplet provides information about the volume of fluid of the droplet, which in turn is related to whether all intended reagents have been deposited, e.g., from a pulse jet deposition device.

In capturing an image of a feature region, an image capture device may be mounted for movement in the X (right and left) and/or Y (back and forth) and/or Z (up and down) directions (and/or the platform or stage upon which an evaluated substrate is positioned may be mounted for movement in the X (right and left) and/or Y (back and forth) and/or Z (up and down) directions). Such movement of the image capture device may be accomplished manually, e.g., with the use of manually actuated control knobs or the like, or automatically by way of an automated driver system controlled, for example, by a processor, to facilitate image capture across an entire substrate so that images of a plurality of deposited droplets may be obtained as the image capture device is moved across a substrate is a precise manner, although a suitable image capture device may be located in a fixed position if desired. The image capture device should have suitable resolution. For example, resolution that provides a pixel size that ranges from about 1 to about 100 micrometers, e.g., provides a pixel size that ranges from about 4 to 10 micrometers, may be employed.

Any suitable analog or digital image capture device (including a line by line scanner) may be used, although if an analog image capturing device is used, the subject methods may include converting the obtained analog image to a digital image, e.g., using a suitable analog/digital converter.

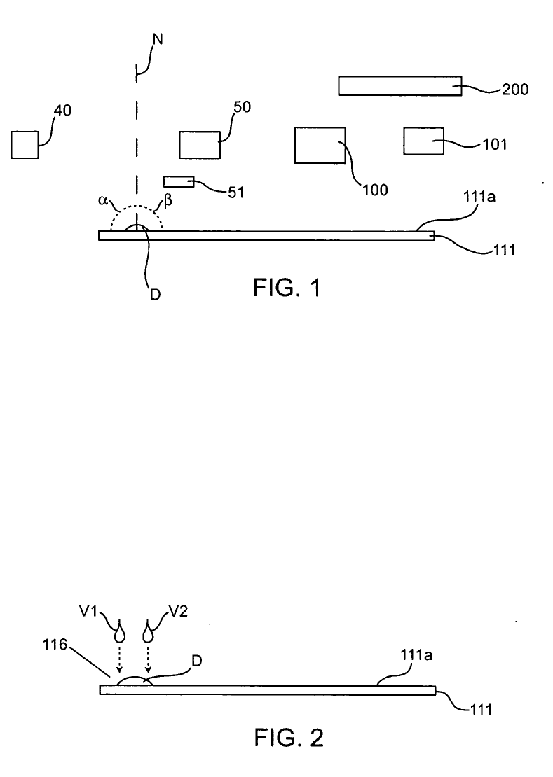

As shown in FIG. 1, light source 40 (which may include one or more light sources) directs light at droplet D deposited on a substrate 111 and an optical property of the droplet is observed. For example, light is directed to droplet D and to camera 50 to “image” the feature region at which droplet D is deposited.

Lighting may be directed at a feature region of an array substrate in a downward, upward, or lateral manner. Light may illuminate the surface of the substrate from the back of the substrate in which case the substrate must be optically transmissive for the light to be transmitted therethrough. Glass, polycarbonate and other transparent materials are suitable as substrate materials if lighting is provided from the back for the substrate, as described herein. The directing of light may be repeated for additional feature regions present on the array substrate surface by scanning the directed light across the substrate. Accordingly, one or more light sources and an image capture device may be scanned across the substrate surface, e.g., in a line by line fashion or otherwise. In one aspect, the one or more light sources and image capture device are scanned in unison across the array. For example, the light source and/or image capture device and/or fluid deposition head may be operably interconnected so that they may be scanned in unison across an array surface. In one aspect, the light source and/or image capture device and/or fluid deposition head are physically interconnected. Such a connection may be permanent; however, in one aspect, the light source and/or image capture device and/or fluid deposition head may be physically connected by an operator prior to or during use of the system.

A lens system (not shown) may be provided to direct light from source 40 to droplet D. Light source 40 may include an optical fiber or fiber bundle (not shown) which communicates light in the visible region (substantially 400 nm to 700 nm) from the source. The light source may be positioned anywhere about angle α relative to normal N with respect to droplet D, where in certain embodiments angle α may range from about 0° to about 90°, e.g., from about 0° to about 5°. In one aspect, the image capture device may include a camera 50 that may include an adjustable focus lens 51 and a linear CCD or other linear sensor (not shown). The camera may be positioned anywhere about angle p relative to normal N with respect to droplet D, where in certain embodiments angle β may range from about 0° to about 90°, e.g., from about 0° to about 5°. The total angle (α+β) may be minimized to provide a compact arrangement (such as less than about 90° or even less than about 5°.), which is limited by the physical size of the components.

The camera may be under the control of a processor. For example, a processor may control the camera to activate the camera at suitable times. In one aspect, a processor controls the fluid deposition device, e.g., to activate fluid deposition at suitable times. Imaging and fluid deposition may be coupled in certain embodiments, e.g., coordinated, for example automatically coordinated by way of one or more suitably programmed processors. In certain embodiments, the camera processor and the fluid deposition device processor are coupled (or are the same) such that whenever the fluid deposition device is activated by the processor, the camera processor is correspondingly triggered to activate the camera to image the feature region at which fluid is deposited.

In certain embodiments, a volume of fluid is deposited onto a substrate surface by a fluid deposition device such as a pulse jet fluid deposition device. The volume of fluid may vary depending on the particular fluid, etc., however in certain embodiments a total volume greater than about 20 pL may at least be intended to be deposited, e.g., a total volume greater than about 90 pL may at least be intended to be deposited. In certain embodiments, the volume of fluid deposited or at least intended to be deposited for a given synthesis layer may range from about 5 pL to about 160 pL or more, e.g., from about 20 pL to about 160 pL or more, e.g., from about 60 pL to about 140 pL, e.g., from about 90 pL to about 120 pL. In one aspect, the volume is deposited at a feature region. Fluid of the deposited droplet may be ejected from one or more nozzles of a pulse jet deposition device. The volume of fluid ejected from each nozzle for a given synthesis layer may vary depending on the particular fluid, etc., however in certain embodiments a volume ranging from about 0.2 to about 5 pL, e.g., from about 0.8 to about 2 pL, e.g., from about 1 to about 1.5 pL is ejected from a given nozzle in certain embodiments.

FIGS. 1 and 2 illustrate embodiments of the subject invention. Inspection of a feature region by capturing one or more images of the feature region upon deposition of a fluid at the region and performing a comparison step to compare a captured image to a reference to provide information about the captured image (and thus the fluid from which the image was obtained), may be carried out one time or at alternate, or multiple times, as desired. For example, an inspection may be performed after each cycle or after a final cycle of a given synthesis protocol. In certain embodiments, images of a given feature region are obtained following each synthesis cycle of a given synthesis protocol. In this manner, images of the entire protocol may be obtained for analysis.

As noted above, a given synthesis layer at least includes a suitable amount of a given monomer and a suitable amount of activator deposited at a given feature region. As shown in FIG. 2, in one aspect a first volume V1 of a given fluid monomer such as a phosphoramidite monomer and a second volume V2 of activator are expelled from respective nozzles of a pulsejet fluid deposition device (not shown) at a feature region 116 of a surface 111a of an array substrate 111 to produce droplet D. In certain embodiments, a plurality of droplets of a given monomer is deposited at region 116 and/or a plurality of droplets of a given activator is deposited at region 116 for a given synthesis layer.

In one aspect, the volume of droplet D may be determined by evaluating one or more optical properties of droplet D. The optical property may be observed in any suitable manner, where imaging techniques are employed in many embodiments to capture an image of the droplet for analysis. In any event, droplet D is illuminated with light and light from the illuminated droplet is directed to an image sensor. Techniques that may be adapted for imaging a droplet according to the subject invention are described, e.g., in U.S. Pat. Nos. 6,589,739 and 6,689,319.

The wavelength of the light used to evaluate a droplet of fluid may vary and any suitable wavelength of the spectrum may be employed. In certain embodiments, the wavelength(s) employed is in the visible region of the spectrum (about 400 nm to about 700 nm).

An imaging capture device such as a camera or video imaging system then captures one or more images of the feature region at which droplet D resides and a grayscale profile is produced. In this regard, an image from image capturing device 50 may be obtained by processor 100 for analysis. The captured image may be stored by processor 100 in memory 101.

The amount of time from the deposition of a fluid droplet at a feature region to image capture of that region is generally short. For example, in certain embodiments a value for the foregoing elapsed time may range from about 0.1 seconds to about 60 seconds or more.

In one aspect, once an image (e.g., such as a grayscale image) is obtained, it is evaluated to determine the volume of the fluid at the feature region. The volume may be a quantitative measurement, e.g., a numeric value indicative of the volume of fluid, or may be qualitative, e.g., a determination of whether the volume is less than (or greater than) it is intended to be made.

This may be accomplished in a number of ways. In one aspect, data relating to an image, such as a grayscale image, is compared to a reference to determine the volume of fluid of the droplet. The reference may be in the form of a lookup table or the like that includes grayscale metrics, e.g., obtained from calibration tests. For example, processor 100 may compare the actual grayscale profile with a reference grayscale profile of a known volume of fluid (or a feature region of known sequence layers), where both grayscale profiles may be present in memory 101.

Processor 100 may then generate a signal from the results of the comparison.

In certain embodiments, a volume determination method may also include measuring the diameter of a deposited droplet of interest to determine the volume of the deposited fluid. In one aspect, both droplet diameter measurements and grayscale interrogation are performed.

Grayscale interrogation may be used to determine the volume of fluid of synthesis layers in which a deposited fluid deposited at the feature site spreads to cover the entire feature site. In certain embodiments, this “spontaneous spreading” point may occur at synthesis layers greater than about 20. The number of layers needed in order for spontaneous wetting to occur depends at least in part on the particular liquid being deposited onto the surface, where the number of layers for spontaneous wetting to occur may be increased for fluid with greater surface energy and reduced for fluids with lower surface energy. At synthesis layers below this spontaneous wetting threshold, a combination of droplet diameter measurements and grayscale interrogation may be used to determine the volume of deposited fluid.

For example, a given synthesis protocol at a given feature region may include measuring the diameter of a deposited droplet of interest determine the volume of the deposited fluid, or may include a combination of measuring the diameter of a deposited droplet of interest to determine the volume of the deposited fluid and grayscale interrogation at synthesis layers from about 1 to about 20 or a portion of such layers, followed by the use of grayscale interrogation or a combination of droplet diameter measurements and grayscale interrogation for synthesis layers greater than about 20 or portions of such layers. Certain embodiments also include employing only grayscale interrogation, as well embodiments that include inspecting synthesis layers of interest using a combination of droplet diameter measurements and grayscale interrogation.

For example, the signal representative of the results of a comparison to a reference may, for example, be a value representing the differences in intended fluid volume versus that of the corresponding actual volume. The value of the comparison signals may be tested against predetermined criteria such as predetermined tolerances, e.g., predetermined ranges or values that are different from or fall outside of the intended fluid volume value or range, but which are considered acceptable for the intended use. When an inspected volume is determined to meet predetermined criteria such as when an inspected volume is determined to fall within the tolerances, it may be considered acceptable for use, i.e., it may be considered error free, and the results of the comparison may not be stored. When a volume of fluid has a comparison value beyond the tolerance it may be considered unacceptable for use, i.e., in error, and an indication of the error may be stored in memory 101, which may be stored in association with an identification of the particular feature region or even synthesis layer. Stored error indication may include an identification of the feature region and/or the type and/or magnitude of the error.

An identifier containing error information regarding an array may be associated with the array by being on the array assembly (such as on the substrate or a housing) that carries the array or on or in a package or kit carrying the array assembly. An identifier may be in the form of bar code or the like on front surface 111a of the array substrate carrying the array inspected according to the subject methods. An identifier may either carry error information (or other information such as array layout information or the like) or an identification linked to such information stored in a remote or non-remote memory, all of which information may be used in a manner the same as described in U.S. Pat. No. 6,180,35 1. Identifiers such as optical, radiofrequency identification (“RF ID”) tags or magnetic identifiers, and the like, may be used instead of bar codes. Error information and/or an associated identifier may be shipped to a user, may be stored onto a portable storage medium for provision to a customer such as a remote customer.

Once the volume of fluid is determined, the volume information may be employed in a variety of ways. For example, volume information may be used to determine whether the fluid deposition device used to deposit the inspected feature region is functioning properly, e.g., to determine any deposition device errors such as whether a nozzle failed to eject some or all of the intended amount of fluid, whether a nozzle ejected too much fluid, etc. In certain embodiments, if it is determined that the device is not functioning properly, the deposition system may be operated to correct for any detected errors, or further operation may be halted. In one aspect, halting operation occurs automatically (e.g., by way of a processor) when deposition device errors are detected. In another aspect, the system may generate operator alerts (e.g., in the form of an alarm (audio or visual), an error message displayed on a user device, email to a user, printout, report, etc), which alerts may be generated automatically (e.g., by way of a processor).

Processor 100 may be programmed to respond in any of a number of ways to errors, which response may either be pre-programmed into processor 100, or a number of different response options may be presented to an operator on a display 200. In one aspect, an operator receives information relating to response options remotely, and may provide information concerning responses to the system remotely as well. Methods for responding to errors which may be adapted for use in the subject invention are described for example, in U.S. Application Ser. No. 09/302,898. If an error is detected, subsequent fluid deposition may be halted and/or subsequent fluid deposition may be altered or modified, e.g., to account for the error.

In certain embodiments, processor 100 may be programmed to direct the associated array to be rejected so that an end user cannot use it. This can be done in a number of ways. For example, processor 100 may direct an operator to manually reject such an identified array by displaying instructions on display 200, which may be an audio or visual output device. The operator may reject the array by, for example, disposing of an entire substrate bearing the rejected array. Alternatively, if automated equipment is used to handle the array substrates, processor 100 may direct an entire substrate carrying such an array into a trash bin. If individual arrays and respective portions of a substrate are separated (such as by cutting) into sections carrying one or more arrays, processor 100 may store an identification of any arrays having unacceptable errors and may track their position and, following separation, direct the pieces carrying those arrays into a trash bin.

In certain embodiments, detection of an error may cause operation of the fluid deposition device to be halted, e.g., automatically by way of processor 100 or by input from an operator alerted to the error by a visible or audible operator alert generated on display (or speaker) 200. This alert may include an identification of the error type and its magnitude.

When one or more errors occur in a given synthesis process, processor 100 may be able to evaluate the cause of the error, e.g., be configured to determine which nozzle of the fluid deposition system failed to fire or otherwise misfired. In some cases, processor 100 may not only be able to evaluate the source of an error, but may also be able to fix or compensate for the errors such as by methods adapted from those described in U.S. Application Ser. No. 09/302,898. Accordingly, embodiments include adjusting an array synthesis protocol, based on the determined volume of an inspected fluid.

Systems

Also provided are systems for fabricating a chemical array on a substrate. An exemplary embodiment of a system according to the subject invention is shown at FIG. 1. Embodiments of the systems include a fluid deposition device (not shown) to deposit a volume of fluid at a feature region of an array substrate, an imaging system such as light source 40 and image capture device 50 to capture an image of the deposited volume, and a processor 100 for causing the imaging system to capture an image of the volume of fluid deposited at a feature region and for comparing the captured image to a reference.

As described above, any suitable fluid deposition device may be employed. Embodiments include pulse jet fluid deposition systems, described herein and elsewhere. To reiterate, such pulse jet systems include a head having multiple pulse jets, each pulse jet including a chamber, and orifice and an ejector which, when activated, causes a volume of fluid to be ejected from the orifice.

Also as described above, any suitable imaging system may be employed, where imaging systems at least include a light source and an image capture device. Imaging systems that may be adapted for use in the subject invention are described for example in U.S. Pat. Nos. 6,589,739 and 6,689,319.

Systems may also one or more processing systems for controlling the function of some or all of the components of the system (e.g., the fluid deposition device and/or imaging system) and/or managing user interface functions and/or data processing. In addition to the above-described control functions, a processor 100 may be configured to cause the volume of fluid deposited at a feature region to be determined, e.g., based on the comparison of the captured image to a reference. In certain embodiments, if it is determined that the volume of the fluid fails to meet a predetermined threshold, the processor may be configured to cause an error indication to be generated, e.g., a visible or audio operator alert generated on an output device 200 associated with the system. In certain embodiments, a processor may be configured to automatically halt further operation of the fluid deposition system and/or and error indication may be included in an identifier associated with the fabricated array.

As described above, a system may include a memory unit 101. The system may be configured to store a variety of information in the memory, e.g., reference data, captured grayscale images and other inspection results (e.g., determined fluid volumes, etc.), and the like.

A system may further include a transporter system for the fluid deposition head, light source and image capture device, so as to move them in a unison or controlled manner relative to each other. A processor may be provided to control the transport system as required and cause the head to dispense droplets of array fabrication reagents at a feature region in coordination with relative movement of the head and substrate.

In certain embodiments, the system is further characterized in that it provides a user interface (not shown), where the user interface presents to a user the option of selecting amongst a plurality of different functions for fabricating a chemical array according to the subject methods, for example the user interface may present to a user the option of selecting amongst a plurality of different functions for using or rejecting a chemical array inspected according to the subject methods, e.g., using or rejecting an error-identified array.

Systems may also include items for fabricating an array, e.g., fluids for fabricating a chemical array, one or more substrates, etc. For example, systems may include and or more of: fluid monomers, e.g., nucleotides or nucleosides or rather deoxynucleoside phosphoramidites such as deoxyadenosine phosphoramidite, deoxyguanosine phosphoramidite, deoxycytidine phosphoramidite, and deoxythrymidine; amino acids, saccharides, peptides; fluid activators, e.g., tetrazole and tetrazole derivatives such as S-ethyl tetrazole, dicyanoimidazole (“DCI”), benzimidazolium triflate, and the like; capping fluids, e.g., a capping solution including acetic anhydride, pyridine or 2,6-lutidine (2,6-dimethylpyridine), and tetrahydrofuran (“THF”), or a capping solution including 1-methyl-imidazole in THF; oxidizing fluids, e.g., an oxidizing solution including iodine in THF, pyridine, and water; deprotecting fluids, e.g., acids; washing fluids; buffering fluids; quality control standards, positive and negative controls, etc.

Computer Readable Media

Embodiments of the subject invention also include computer readable media having programming stored thereon for implementing some or all of the subject methods. For example, a computer readable medium having programming for controlling a system as described above to observe an optical property of a volume of fluid at a feature region of an array substrate surface and to determine the volume of the deposited volume of fluid based on the observed optical property.

The computer readable media may be, for example, in the form of a computer disk or CD, a floppy disc, a magnetic “hard card”, a server, or any other computer readable media capable of containing data or the like, stored electronically, magnetically, optically or by other means. Accordingly, stored programming may be transferred to a system or to a computer coupled to a system such as a personal computer (PC), (i.e., accessible by an operator or the like), by physical transfer of a CD, floppy disk, or like medium, or may be transferred using a computer network, server, or other interface connection, e.g., the Internet.

Chemical Arrays

Also provided by the subject invention are arrays produced according to the subject methods. That is, the subject methods include array assemblies that include one or more arrays or one or more feature regions of at least one array of an array assembly inspected according to the subject methods.

Arrays find use in a variety of applications, including gene expression analysis, drug screening, nucleic acid sequencing, mutation analysis, and the like. These chemical arrays include a plurality of ligands or molecules or probes (i.e., binding agents or members of a binding pair) deposited onto the surface of a substrate in the form of an “array” or pattern.

The subject arrays include at least two distinct polymers that differ by monomeric sequence attached to different and known locations on the substrate surface. Each distinct polymeric sequence of the array is typically present as a composition of multiple copies of the polymer on a substrate surface, e.g., as a spot or feature on the surface of the substrate. The number of distinct polymeric sequences, and hence spots or similar structures, present on the array may vary, where a typical array may contain more than about ten, more than about one hundred, more than about one thousand, more than about ten thousand or even more than about one hundred thousand features in an area of less than about 20 cm² or even less than about 10 cm². For example, features may have widths (that is, diameter, for a round spot) in the range from about 10 μm to about 1.0 cm. In other embodiments, each feature may have a width in the range from about 1.0 μm to about 1.0 mm, usually from about 5.0 μm to about 500 μm and more usually from about 10 μm to about 200 μm. Non-round features may have area ranges equivalent to that of circular features with the foregoing width (diameter) ranges. At least some, or all, of the features are of different compositions (for example, when any repeats of each feature composition are excluded, the remaining features may account for at least about 5%, 10% or 20% of the total number of features). Interfeature areas will typically (but not essentially) be present which do not carry any polynucleotide (or other biopolymer or chemical moiety of a type of which the features are composed). It will be appreciated though, that the interfeature areas, when present, could be of various sizes and configurations. The spots or features of distinct polymers present on the array surface are generally present as a pattern, where the pattern may be in the form of organized rows and columns of spots, e.g. a grid of spots, across the substrate surface, a series of curvilinear rows across the substrate surface, e.g. a series of concentric circles or semi-circles of spots, and the like.

An array includes any one or two-dimensional or substantially two-dimensional (as well as a three-dimensional) arrangement of addressable regions bearing a particular chemical moiety or moieties (e.g., biopolymers such as polynucleotide or oligonucleotide sequences (nucleic acids), polypeptides (e.g., proteins), carbohydrates, lipids, etc.) associated with that region. In the broadest sense, the arrays are arrays of polymeric or biopolymeric ligands or molecules, i.e., binding agents, where the polymeric binding agents may be any of: peptides, proteins, nucleic acids, polysaccharides, synthetic mimetics of such biopolymeric binding agents, etc. In many embodiments, the arrays are peptide arrays and arrays of nucleic acids, including oligonucleotides, polynucleotides, cDNAs, mRNAs, synthetic mimetics thereof, and the like.

A variety of solid supports or substrates may be used, upon which an array may be positioned, as described above. In certain embodiments, a plurality of arrays may be stably associated with one substrate. For example, a plurality of arrays may be stably associated with one substrate, where the arrays are spatially separated from some or all of the other arrays associated with the substrate.

Each array may cover an area of less than about 100 cm², or even less than about 50 cm², 10 cm² or 1 cm². In many embodiments, the substrate carrying the one or more arrays will be shaped generally as a rectangular solid (although other shapes are possible), having a length of more than about 4 mm and less than about 1 m, usually more than about 4 mm and less than about 600 mm, more usually less than about 400 mm; a width of more than about 4 mm and less than about 1 m, usually less than about 500 mm and more usually less than about 400 mm; and a thickness of more than about 0.01 mm and less than about 5.0 mm, usually more than about 0.1 mm and less than about 2 mm and more usually more than about 0.2 and less than about 1 mm. Substrates having shapes other than rectangular may have analogous dimensions. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least about 20%, or about 50% (or even at least about 70%, 90%, or 95%), of the illuminating light incident on the substrate as may be measured across the entire integrated spectrum of such illuminating light or alternatively at 532 nm or 633 nm.

The subject array assemblies find use in a variety of different applications, where such applications are generally analyte detection applications in which the presence of a particular analyte (i.e., target) in a given sample is detected at least qualitatively, if not quantitatively. Protocols for carrying out such assays are well known to those of skill in the art and need not be described in great detail here. Generally, the sample suspected of containing the analyte of interest is contacted with an array generated on a surface of a prong under conditions sufficient for the analyte to bind to its respective binding pair member (i.e., probe) that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface. Specific analyte detection applications of interest include, but are not limited to, hybridization assays in which nucleic acid arrays are employed.

In these assays, a sample to be contacted with an array may first be prepared, where preparation may include labeling of the targets with a detectable label, e.g. a member of signal producing system. Such detectable labels include, but are not limited to, radioactive isotopes, fluorescers, chemiluminescers, enzymes, enzyme substrates, enzyme cofactors, enzyme inhibitors, dyes, metal ions, metal sols, ligands (e.g., biotin or haptens) and the like. Thus, at some time prior to the detection step, described below, any target analyte present in the initial sample contacted with the array may be labeled with a detectable label. Labeling can occur either prior to or following contact with the array. In other words, the analyte, e.g., nucleic acids, present in the fluid sample contacted with the array may be labeled prior to or after contact, e.g., hybridization, with the array. In some embodiments, the sample analytes e.g., nucleic acids, are directly labeled with a detectable label, wherein the label may be covalently or non-covalently attached to the nucleic acids of the sample. For example, in the case of nucleic acids, the nucleic acids, including the target nucleotide sequence, may be labeled with biotin, exposed to hybridization conditions, wherein the labeled target nucleotide sequence binds to an avidin-label or an avidin-generating species. In an alternative embodiment, the target analyte such as the target nucleotide sequence is indirectly labeled with a detectable label, wherein the label may be covalently or non-covalently attached to the target nucleotide sequence. For example, the label may be non-covalently attached to a linker group, which in turn is (i) covalently attached to the target nucleotide sequence, or (ii) comprises a sequence which is complementary to the target nucleotide sequence. In another example, the probes may be extended, after hybridization, using chain-extension technology or sandwich-assay technology to generate a detectable signal (see, e.g., U.S. Pat. No. 5,200,314).

In certain embodiments, the label is a fluorescent compound, i.e., capable of emitting radiation (visible or invisible) upon stimulation by radiation of a wavelength different from that of the emitted radiation, or through other manners of excitation, e.g. chemical or non-radiative energy transfer. The label may be a fluorescent dye. Usually, a target with a fluorescent label includes a fluorescent group covalently attached to a nucleic acid molecule capable of binding specifically to the complementary probe nucleotide sequence.

Following sample preparation (labeling, pre-amplification, etc.), the sample may be introduced to the array using any convenient protocol, e.g., sample may be introduced using a pipette, syringe or any other suitable introduction protocol. The sample is contacted with the array under appropriate conditions to form binding complexes on the surface of the substrate by the interaction of the surface-bound probe molecule and the complementary target molecule in the sample. The presence of target/probe complexes, e.g., hybridized complexes, may then be detected.

In the case of hybridization assays, the sample is typically contacted with an array under stringent hybridization conditions, whereby complexes are formed between target nucleic acids that agent are complementary to probe sequences attached to the array surface, i.e., duplex nucleic acids are formed on the surface of the substrate by the interaction of the probe nucleic acid and its complement target nucleic acid present in the sample.

The array is incubated with the sample under appropriate array assay conditions, e.g., hybridization conditions, as mentioned above, where conditions may vary depending on the particular biopolymeric array and binding pair.

Once the incubation step is complete, the array is typically washed at least one time to remove any unbound and non-specifically bound sample from the substrate, generally at least two wash cycles are used. Washing agents used in array assays are known in the art and, of course, may vary depending on the particular binding pair used in the particular assay. For example, in those embodiments employing nucleic acid hybridization, washing agents of interest include, but are not limited to, salt solutions such as sodium, sodium phosphate (SSP) and sodium, sodium chloride (SSC) and the like as is known in the art, at different concentrations and which may include some surfactant as well. In certain embodiments the wash conditions described above may be employed.

Following the washing procedure, the array may then be interrogated or read to detect any resultant surface bound binding pair or target/probe complexes, e.g., duplex nucleic acids, to obtain signal data related to the presence of the surface bound binding complexes, i.e., the label is detected using calorimetric, fluorimetric, chemiluminescent, bioluminescent means or other appropriate means. The obtained signal data from the reading may be in any convenient form, i.e., may be in raw form or may be in a processed form.

Reading of the array(s) to obtain signal data may be accomplished by illuminating the array(s) and reading the location and intensity of resulting fluorescence (if such methodology was employed) at each feature of the array(s) to obtain a result. For example, an array scanner may be used for this purpose that is similar to the Agilent MICROARRAY SCANNER available from Agilent Technologies, Palo Alto, Calif. Other suitable apparatus and methods for reading an array to obtain signal data are described in U.S. patent application Ser. No. 09/846125“Reading Multi-Featured Arrays” by Dorsel et al.; and Ser. No. 09/430214“Interrogating Multi-Featured Arrays” by Dorsel et al., the disclosures of which are herein incorporated by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583, the disclosure of which is herein incorporated by reference, and elsewhere).

Results of the array reading (processed or not) may be forwarded (such as by communication) to a remote location if desired, and received there for further use (such as further processing). The data may be transmitted to the remote location for further evaluation and/or use. Any convenient telecommunications means may be employed for transmitting the data, e.g., facsimile, modem, Internet, etc.

As noted above, the arrays produced according to the subject method may be employed in a variety of array assays including hybridization assays. Specific hybridization assays of interest which may be practiced using the subject arrays include: gene discovery assays, differential gene expression analysis assays; nucleic acid sequencing assays, and the like. Patents describing methods of using arrays in various applications include: U.S. Pat. Nos. 5,288,644; 5,324,633; 5,432,049; 5,470,710; 5,492,806; 5,503,980; 5,525,464; 5,580,732; and 5,661,028.

Other array assays of interest include those where the arrays are arrays of polypeptide binding agents, e.g., protein arrays, where specific applications of interest include analyte detection/proteomics applications, including those described in U.S. Pat. Nos. 4,591,570; 5,171,695; 5,436,170; 5,486,452; 5,532,128; and 6,197,599; as well as published PCT application Nos. WO 99/39210; WO 00/04832; WO 00/04389; WO 00/04390; WO 00/54046; WO 00/63701; WO 01/14425; and WO 01/40803.

Kits

In aspects of the subject invention, one or more of array assemblies having one or more chemical arrays produced in accordance with the subject invention may be present in a kit format. A kit may include error information related to a chemical arrays of the array assembly, where the error information may be included in an identifier associated with the array assembly. The subject kits may also include instructions for how to use error information. The instructions may be recorded on a suitable recording medium or substrate. For example, the instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, this means for obtaining the instructions is recorded on a suitable substrate.

The kits may further include one or more additional components necessary for carrying out an array assay, such as sample preparation reagents, buffers, labels for labeling components of interest of a sample such as for labeling a nucleic acid or the like, etc. As such, the kits may include one or more containers such as vials or bottles, with each container containing a separate component for the measurement of an optical property of a sample.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A method comprising:
(a) depositing a volume of fluid at a feature region of an array substrate surface; and
(b) observing a property of said feature region comprising said deposited volume to determine said volume of fluid deposited at said feature region.

2. The method of claim 1, wherein said volume comprises at least one of an activator and a monomer.

3. The method of claim 2, wherein said volume comprises an activator.

4. The method of claim 3, wherein said activator is an acid.

5. The method of claim 4, wherein said acid is tetrazole or a tetrazole derivative.

6. The method of claim 2, wherein said volume comprises a monomer.

7. The method of claim 6, wherein said monomer is a nucleoside or nucleotide.

8. The method of claim 1, wherein said observing comprises capturing an image of said deposited volume.

9. The method of claim 8, wherein said image is a grayscale image.

10. The method of claim 9, wherein said method comprises comparing said grayscale image to a reference.

11. The method of claim 8, wherein, whenever a volume of fluid is deposited at a feature region of an array substrate surface, an image of said deposited volume is automatically captured at the feature region.

12. The method of claim 1, further comprising halting deposition or altering subsequent deposition of fluid if said determined volume fails to meet a predetermined criteria.

13. The method of claim 1, wherein said deposition step (a) comprises depositing a second volume of fluid onto a previously deposited first volume at said feature region.

14. The method of claim 13, wherein the volume of said previously deposited volume of fluid has been determined according to the method of claim 1.

15. The method of claim 1, wherein said volume is deposited using a fluid deposition device.

16. The method of claim 15, wherein said fluid deposition device is a pulse jet fluid deposition device.

17. The method of claim 1, wherein said property is an optical property.

18. The method of claim 1, wherein said method is a method of fabricating a chemical array.

19. A method of performing an array assay, said method comprising:
(a) contacting a sample to at least one chemical array fabricated according to the method of claim 1; and
(b) detecting the presence of any binding complexes from said chemical array.

20. A system comprising:
(a) a fluid deposition system to deposit a volume of fluid at a feature region of an array substrate surface;
(b) a system for measuring the volume of said deposited fluid; and
(c) a processor.

21. The system of claim 20, wherein said processor is configured to compare said measured volume of fluid to a reference.

22. The system of claim 21, wherein said processor is configured to cause the volume of fluid deposited at said feature region to be determined based on said comparison.

23. The system of claim 22, wherein, when said determined volume fails to meet predetermined criteria, said processor is configured to cause an error indication to be generated.

24. The system of claim 23, wherein said system comprises an audio or visual output device and said error indication comprises a generation of a visible or audible operator alert on said output device.

25. The system of claim 23, wherein said error indication automatically halts further operation of said fluid deposition system.

26. The system of claim 23, wherein said error indication is included in an identifier associated with said chemical array.

27. The system of claim 20, wherein said system further comprises a memory.

28. The system of claim 27, wherein said memory includes a reference.

29. The system of claim 20, wherein said fluid deposition system comprises a head having multiple pulse jets each in fluid communication with a chamber and an orifice and an ejector which, when activated, causes a volume of fluid to be ejected from said orifice.

30. The system of claim 20, wherein said system for measuring the volume of said deposited fluid is an imaging system for capturing an image.

31. The system of claim 20, wherein said fluid deposition system and said system for measuring the volume of said deposited fluid are coupled.

32. A computer-readable medium comprising a program for controlling a system to:
(a) observe an property of a volume of fluid deposited at a feature region of an array substrate surface; and
(b) determine the volume of said deposited volume of fluid based on said observed property.

33. The computer readable medium of claim 32, wherein said property is an optical property.

34. A kit comprising:
an array; and
error information obtained by a method according to claim 1 and associated with said array assembly.
